(19) United States
(12) Patent Application Publication
(10) Pub. No.: US 2008/0298652 A1
(43) Pub. Date: Dec. 4, 2008

(54) METHOD AND SYSTEM OF PREVIEWING PREVIOUS AND FORWARD FRAMES OF A SELECTED END OF DIASTOLE OR END OF SYSTOLE FRAME CANDIDATE

(75) Inventors: Weng Lei, Mount Prospect, IL (US); John Baumgart, Hoffman Estates, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/050,359

(22) Filed: Mar. 18, 2008

Related U.S. Application Data
(60) Provisional application No. 60/940,783, filed on May 30, 2007.

(51) Int. Cl. G06K 9/00

(52) U.S. Cl. 382/128

(57) ABSTRACT

A method and system for viewing a series of medical image frames. The method and system displays a candidate medical image frame selected from the series of medical image frames, in a first portion of a display screen of a user interface; displays, in a second portion of the display screen of the user interface, a first alternate candidate medical image frame of the series of medical image frames which precedes or follows the candidate medical image frame in the series of medical image frames; and displays the first alternate candidate medical image frame in the first portion of the display screen when the first alternate candidate medical image frame displayed in the second portion of the display screen is selected, via the user interface, for display on the first portion of the display screen.

### RELATED APPLICATIONS

This application claims the benefit of U.S. Provisional Application Ser. No. 60/940,783 filed on May 30, 2007, the entire disclosure of which is incorporated herein by reference.

### FIELD

The disclosure relates to cardiac analysis. More particularly, the disclosure relates to a method and system for previewing image frames that precede or follow an automatically selected candidate image frame showing a desired phase of a cardiac cycle including but not limited to end of diastole and end of systole.

### BACKGROUND

The heart contracts and relaxes with each heartbeat or cardiac cycle. During the contraction phase (systole), the heart ejects blood from two pumping chambers called ventricles. During the relaxation phase (diastole), the ventricles of the heart refill with blood.

Not all of the blood is emptied from the ventricles of the heart during the contraction or systole phases. End of systole (ES) refers to the volume of blood remaining in the ventricles immediately after systole and before the beginning of ventricular relaxation or diastole whereas ejection fraction refers to the percentage of blood which is pumped out of a filled ventricle during systole. End of diastole (ED) refers to the volume of blood remaining in the ventricles at the end of filling, i.e., when the ventricles refill with blood.

Some cardiac procedures involve a Left Ventricle Analysis (LVA) to analyze the ejection fraction, ED volume, ES volume, and other operating parameters of the heart. The analysis focuses on the left ventricle because it is the heart's main pumping element.

LVA may be performed on a medical imaging system running an LVA application that enables the system to automatically select candidate ED or ES image frames from an angiography series (which typically comprise x-ray image frames of the left ventricle of the heart after the addition of a radiocontrast agent to the blood) and displays them to the user (e.g. cardiologist) for LVA. The cardiologist must view the automatically selected ED and ES image frame candidates and decide whether these image frames are appropriate for LVA.

Current imaging systems are only capable of displaying one image frame at a time on a system monitor or display. Thus, when viewing the automatically selected candidate ED and ES image frames, the cardiologist must use a single step forward or backward button to step through image frames in the image area one at a time, to determine whether to accept the automatically selected candidate ED and ES image frames or to manually pick different ED and/or ES image frames if the automatically selected candidate ED and/or ES image frames are not appropriate for LVA. This process is manual and time-consuming.

Accordingly, there is need for a method and system that reduces the time required to preview image frames, which precede or follow the automatically selected candidate end of diastole and end of systole image frames.

### SUMMARY

A method is disclosed for viewing a series of medical image frames. The method comprises the steps of: displaying a candidate medical image frame selected from the series of medical image frames, in a first portion of a display screen of a user interface; displaying, in a second portion of the display screen of the user interface, a first alternate candidate medical image frame of the series of medical image frames which precedes or follows the candidate medical image frame in the series of medical image frames; and displaying the first alternate candidate medical image frame in the first portion of the display screen when the first alternate candidate medical image frame displayed in the second portion of the display screen is selected, via the user interface, for display on the first portion of the display screen.

Also disclosed is a system for viewing a series of medical image frames. The system comprises: a user interface comprising a display screen for displaying medical image frames; a processor in communication with the user interface, the processor executing instructions for: displaying a candidate medical image frame selected from the series of medical image frames, in a first portion of the display screen; displaying, in a second portion of the display screen, a first alternate candidate medical image frame of the series of medical image frames which precedes or follows the candidate medical image frame in the series of medical image frames; and displaying the first alternate candidate medical image frame in the first portion of the display screen when the first alternate candidate medical image frame displayed in the second portion of the display screen is selected, via the user interface, for display on the first portion of the display screen.

Further disclosed is a system for viewing a series of medical image frames. The system comprises: means for displaying a candidate medical image frame selected from the series of medical image frames, in a first portion of a display screen of a user interface; means for displaying, in a second portion of the display screen, a first alternate candidate medical image frame of the series of medical image frames which precedes or follows the candidate medical image frame in the series of medical image frames; and means for displaying the first alternate candidate medical image frame in the first portion of the display screen when the first alternate candidate medical image frame displayed in the second portion of the display screen is selected, via the user interface, for display on the first portion of the display screen.

Still further disclosed is a computer-readable medium having stored thereon computer-executable instructions which when executed by a computer system cause the system to perform a method for viewing a series of medical image frames. The method comprises steps of: displaying a candidate medical image frame selected from the series of medical image frames, in a first portion of a display screen of a user interface; displaying, in a second portion of the display screen, a first alternate candidate medical image frame of the series of medical image frames which precedes or follows the candidate medical image frame in the series of medical image frames; and displaying the first alternate candidate medical image frame in the first portion of the display screen when the first alternate candidate medical image frame displayed in the second portion of the display screen is selected, via the user interface, for display on the first portion of the display screen.

### BRIEF DESCRIPTION OF THE DRAWINGS

FIG. 1 is flow chart showing an exemplary embodiment of the method for previewing medical image frames that precede or follow the selected candidate image frame.

FIG. 2 shows images frames displayed on a display screen of a user interface according to one embodiment of the method.

FIGS. 3A and 3B show images frames displayed on a display screen of a user interface according to another embodiment of the method.

FIG. 4 is a block diagram of an exemplary embodiment of the system for automatically finding candidate image frames and performing the medical image frame previewing method.

### DETAILED DESCRIPTION

A method and a system are described herein for previewing medical image frames that precede or follow a selected candidate image frame showing a desired phase of a cardiac cycle. In one embodiment, the phase of the cardiac cycle is end of diastole ED. In another embodiment, the phase of the cardiac cycle is end of systole (ES). In one embodiment, the medical image frames comprise x-ray image frames of a cardiac angiography series. In another embodiment, the medical image frames comprise magnetic resonance image frames of a cardiac angiography series.

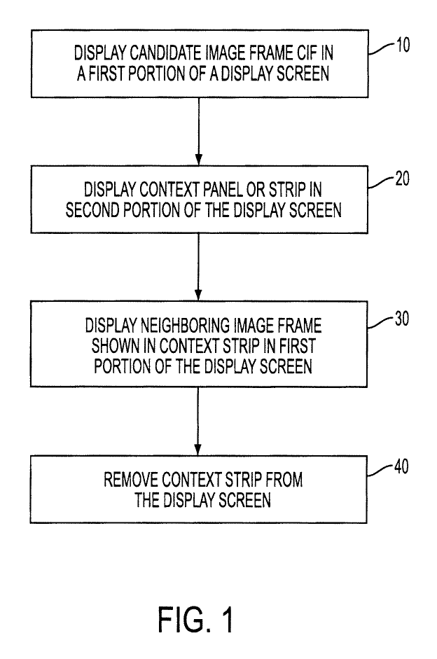

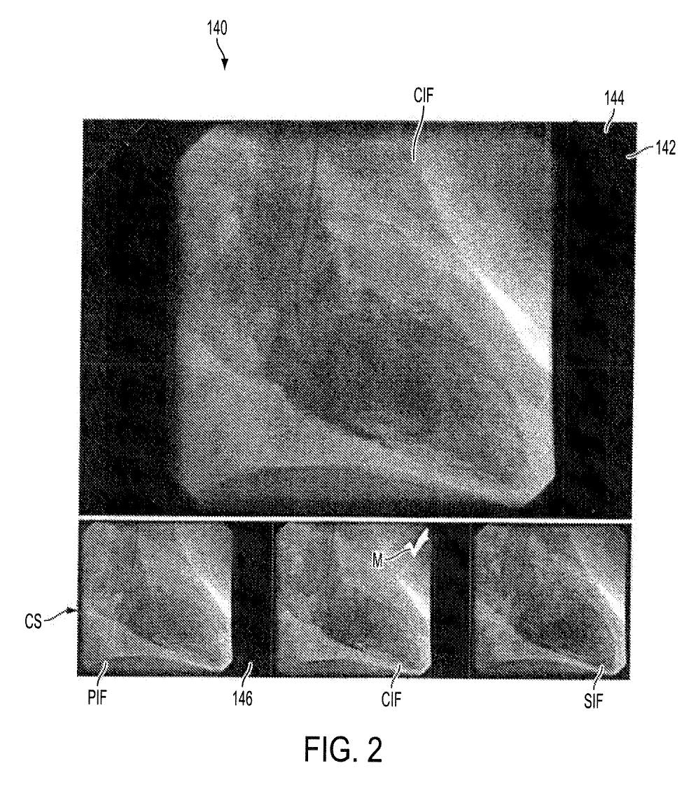

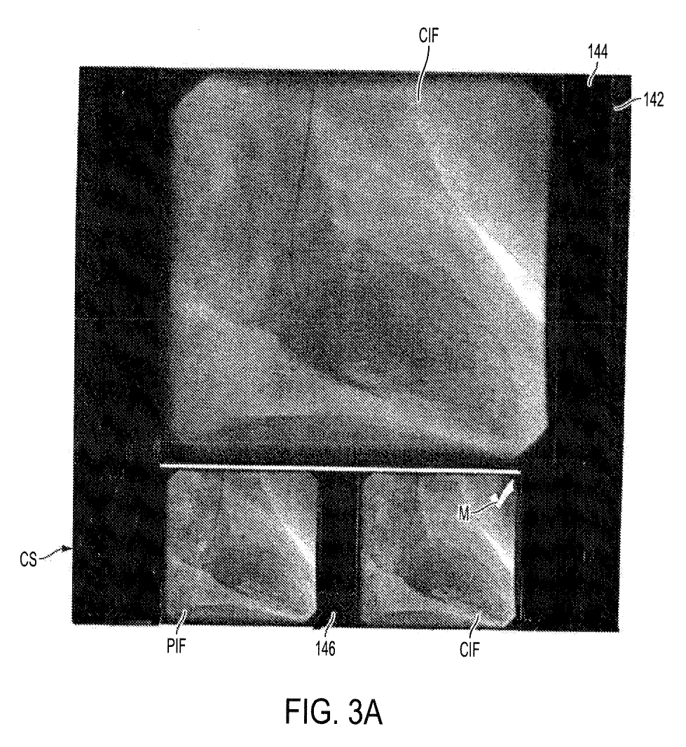

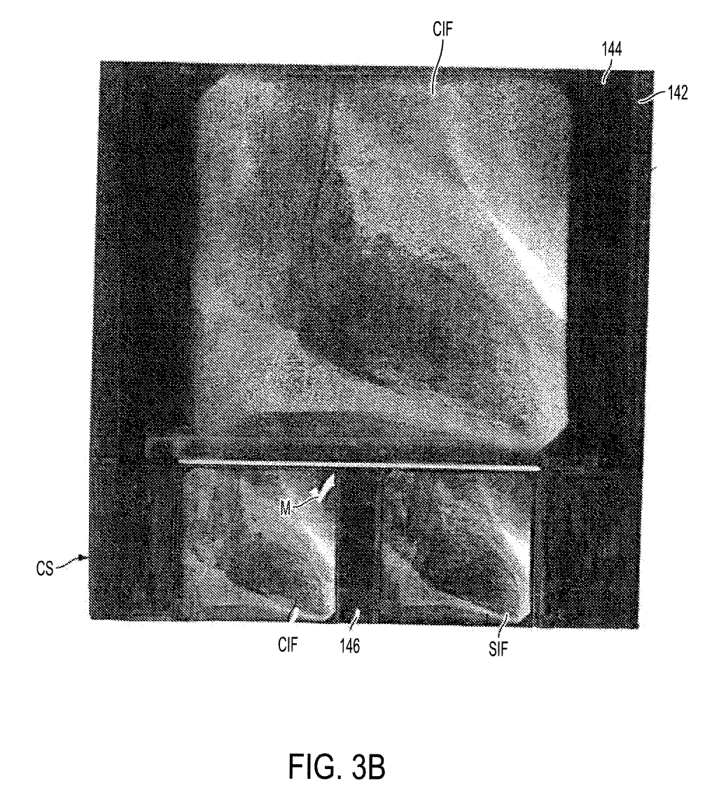

FIG. 1 is flow chart showing an exemplary embodiment of the method for previewing medical image frames that precede or follow the selected candidate image frame. In step 10, a medical imaging system displays or causes to be displayed a candidate image frame CIF of a desired cardiac cycle phase in a first portion 144 of a display screen 142 of a user interface 140, as shown in FIG. 2. In step 20, the system displays a context panel or strip CS in a second portion 146 of the display screen 142 of the user interface 140, as shown in FIG. 2. The context strip CS may show the candidate image frame CIF in the context of one or more neighboring image frames in the corresponding cardiac angiography series of images. In FIG. 2, the neighboring images include at least one previous image frame PIF in the corresponding cardiac angiography series of images and at least one successive image frame SIF in the corresponding cardiac angiography series of images. Alternatively, the context strip CS may show the candidate image frame CIF in the context of a neighboring image frame in the corresponding cardiac angiography series where the neighboring image frame is at least one previous image frame PIF, as shown in FIG. 3A, or where the neighboring image frame is at least one successive image frame SIF, as shown in FIG. 3B.

Typically, the displayed candidate image frames CIF have previously been automatically selected by the system. In one embodiment, the candidate image frames CIF may be automatically selected as described in U.S. Non-Provisional patent application Ser. No. 11/848,505, entitled SYSTEM AND METHOD FOR SELECTING END OF DIASTOLE AND END OF SYSTOLE FRAMES, which claims the benefit of U.S. Provisional Application Ser. No. 60/916,329 filed on May 7, 2007. The entire disclosure of this Non-Provisional patent application is incorporated herein by reference.

Referring again to FIGS. 1 and 2, a neighboring image frame, i.e., a previous image frame PIF or successive image frame SIF displayed in the context strip CS, is displayed in the first portion 144 of the display screen 142 in step 30, when selected for display in the first portion 144 of the display screen 142 by the user, via a first input element of the user interface 140, including but not limited to a mouse, a joystick, and a touch-screen. The context strip CS, thus, allows a user to determine whether a neighboring image frame PIF or SIF is a better example of the cardiac cycle phase of interest than the candidate image frame CIF selected by the system. When the cardiac cycle phase of interest comprises an ED or ES image frame, the method and system will enable the user to determine by visual inspection whether the automatically selected candidate image frame CIF is appropriate for LVA.

Referring again to FIG. 2, the first portion 144 of the display screen 142 displays the currently selected image frame, i.e., the automatically selected candidate image frame CIF or one of the neighboring image frames PIF or SIF selected by the user, in a large format (an area larger than the second portion). The second portion 146 of the display screen 142 displays the image frames forming the context strip CS in a reduced size format (an area less than the first portion). As shown, the first portion 144 of the display screen 142 may comprise an upper portion of the display screen 142 and the second portion 146 of the display screen 142 may comprise a lower portion of the display screen 142. In an alternate embodiment, the first portion 144 of the display screen 142 may comprise the lower portion of the display screen 142 and the second portion 146 of the display screen 142 may comprise the upper portion of the display screen 142. In a further embodiment, the first portion 144 of the display screen 142 may comprise a lateral or side portion of the display screen 142 and the second portion 146 of the display screen 142 may comprise an opposing lateral or side portion of the display screen 142.

The context strip CS displayed in the display screen 142 in one embodiment comprises a floating window, e.g., a window that may be positioned arbitrarily within the main image shown on the entire display screen or a portion of the display screen (the entire display screen or the portion thereof being the first portion of the display screen and the floating window being the second portion of the display screen in this embodiment) without a cooperately changing the size and shape of the main image. The context strip CS in a second embodiment comprises a docked window, e.g., a window positioned cooperatively with the main image shown on the display screen (as illustrated in FIGS. 2, 3A, and 3B where the main image is displayed in the first portion 144 of the display screen 142 and the context strip CS is displayed in the second portion 146 of the display screen 142), which may be resized and/or made into a floating window. The context strip CS in a third embodiment comprises a fixed window, e.g., a window positioned cooperatively with another window (as illustrated in FIGS. 2, 3A, and 3B where the main image is displayed in the first portion 144 of the display screen 142 and the context strip CS is displayed in the second portion 146 of the display screen 142), which cannot resized and/or moved.

In one embodiment, a marker M may be displayed in or adjacent to the automatically selected candidate image frame CIF shown in the context strip CS, to identify that image frame as the automatically selected candidate image frame CIF.

A second user interface element may be provided to allow the user to step forward or backward from the currently displayed image frame (the candidate image frame or neighboring image frames PIF or SIF) within the series of angiography image frames. In embodiments where the context strip CS shows the candidate image frame CIF in the context of at least one previous image frame PIF and at least one successive image frame SIF (e.g., FIG. 2), the context strip CS will be updated to locate the new currently displayed image frame within the center of the context strip CS with its preceding and succeeding image frames located on respective sides of the currently displayed image frame.

A third user interface element may be provided to allow the user to select the image frame currently displayed in the first portion 144 of the display screen 142 (the large format portion) as the most appropriate for a heart analysis further on. When the phase of interest comprises ED or ES image frames, the third user interface element allows the user to select the ED or ES image frame most appropriate for LVA or other heart analysis. The procedure for selecting the appropriate image frame will be repeated for both ED and ES image frames.

In step 40, the context strip CS is removed from the display screen 142 and the standard workflow for continuing the heart analysis, e.g., LVA may be continued.

As one of ordinary skill in the art will appreciate, the context strip CS enables the user to preview the preceding and/or succeeding frames of the selected image frame candidates, and thus, makes the process of selecting image frames for heart analysis, particularly, ED and ES frames, more efficient for cardiologists and other users.

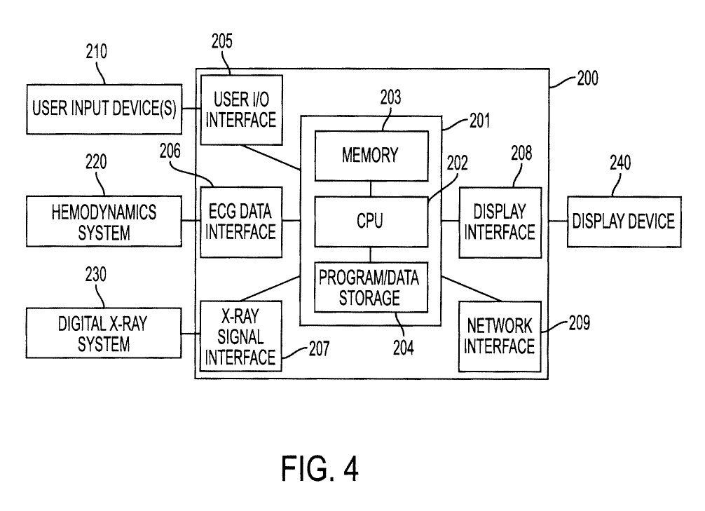

FIG. 4 shows a block diagram of an exemplary embodiment of the system that may used for carrying out the method described herein. The system comprises a computer system 200 including a computer 201 in data communication with a user input/output (I/O) interface 205, an ECG data interface 206, an x-ray signal interface 207, a user display interface 208 and a network interface 209. The system further comprises external peripheral devices and sub-systems including one or more user input devices 210, a hemodynamics sub-system 220, a digital x-ray sub-system 230, and a display device or monitor 240.

The computer 201 includes a central processing unit (CPU) 202 in communication with a memory 203 and a program/data storage unit 204. The program/data storage unit 204 provides long-term storage of programs and data associated with the method described herein while the memory 203 provides temporary storage of programs and data associated with the method describe herein. The CPU 202 executes the programs (e.g., algorithms) associated with the method describe herein which are stored in the program/data storage unit 204 and memory 203.

The one or more user input devices 210, in one exemplary embodiment, includes a keyboard, mouse, microphone, and joystick, for generating digital user input data for controlling and operating the system. In other embodiments, the one or more user input devices 210 may include, the display screen of the monitor 140 (touch-screen), trackballs, pen lights and any other suitable user input device or combination of devices. The digital user input data generated by one or more user input devices 210 is supplied to the computer 201 via the user I/O interface 205. The display device 240 may be a conventional or unconventional monitor or display screen for displaying images and data. The user interface 140 described above may include without limitation the input devices 210 and the display device 240.

The hemodynamics sub-system 220 may include conventional and unconventional means for obtaining digital ECG and blood pressure data (aortic, ventricular and atrial pressure data) of the patient's heart. Such means may include invasive and/or non-invasive devices for obtaining digital ECG and blood pressure data of the patient's heart. The digital ECG and blood pressure data generated by the hemodynamics sub-system 220 is supplied to the computer 201 via the ECG data interface 206.

The digital x-ray sub-system 230 may include conventional and unconventional means for generating the angiography series comprising the plurality of digital x-ray images frames of the patients heart and digital x-ray image data corresponding to the angiography series. The digital x-ray image data generated by the x-ray sub-system 230 is supplied to the computer 201 via the x-ray signal interface 207.

The user I/O, ECG data, x-ray signal, display and network interfaces 205, 206, 207, 208, 209 may be conventional or unconventional in design and operation.

The computer 210 processes and analyzes the digital ECG, blood pressure and x-ray image data in accordance with the methods described in aforementioned Non-Provisional U.S. patent application to select best ED and ES x-ray image frame candidates. The selected ED and ES x-ray image frame candidates are displayed by the system on the display device 240 for acceptance or rejection by the user.

The network interface 209 allows data corresponding to the selected ED and ES x-ray image frames to be communicated to another computer, a database, and the like over a computer network including, without limitation, a wide area network or local-area network.

Although the foregoing disclosure is directed to exemplary embodiments, it is noted that other variations and modification will be apparent to those skilled in the art, and may be made without departing from the spirit or scope of the disclosure.

What is claimed is:

1. A method for viewing a series of medical image frames, the method comprising the steps of:
displaying a candidate medical image frame selected from the series of medical image frames, in a first portion of a display screen of a user interface;
displaying, in a second portion of the display screen of the user interface, a first alternate candidate medical image frame of the series of medical image frames which precedes or follows the candidate medical image frame in the series of medical image frames; and
displaying the first alternate candidate medical image frame in the first portion of the display screen when the first alternate candidate medical image frame displayed in the second portion of the display screen is selected, via the user interface, for display on the first portion of the display screen.

2. The method according to claim 1, wherein the first portion of the display screen has an area which is greater than an area of the second portion of the display screen.

3. The method according to claim 1, wherein the second portion of the display screen comprises a movable window.

4. The method according to claim 1, wherein the second portion of the display screen comprises a docked or fixed window.

5. The method according to claim 1, wherein the candidate medical image frame in the second portion of the display screen is identified by a marker.

6. The method according to claim 1, wherein the series of image frames comprise x-ray image frames.

7. The method according to claim 1, wherein the series of image frames comprise angiography image frames.

8. The method according to claim 1, wherein the candidate image frame comprises a candidate end of diastole image frame or a candidate end of systole image frame.

9. The method according to claim 1, wherein the first alternate candidate medical image frame precedes the candidate medical image frame and further comprising the step of displaying, in the second portion of the display screen, a second alternate medical image frame of the series of medical image frames which follows the candidate medical image frame in the series of medical image frames.

10. The method according to claim 9, further comprising the step of displaying the second alternate candidate medical image in the first portion of the display screen when the second alternate candidate medical image frame displayed in the second portion of the display screen is selected, via the user interface, for display on the first portion of the display screen.

11. The method according to claim 9, wherein the candidate medical image frame comprises a candidate end of diastole image frame or a candidate end of systole image frame, the first alternate candidate medical image frame comprises a first alternate candidate end of diastole image frame or a first alternate candidate end of systole image frame, and the second alternate candidate medical image frame comprises a second alternate candidate end of diastole image frame or a second alternate candidate end of systole image frame.

12. The method according to claim 1, further comprising the step of displaying the candidate medical image in the first portion of the display screen when the candidate medical image frame displayed in the second portion of the display screen is selected, via the user interface, for display on the first portion of the display screen.

13. A system for viewing a series of medical image frames, the system comprising:
a user interface comprising a display screen for displaying medical image frames;
a processor in communication with the user interface, the processor executing instructions for:
displaying a candidate medical image frame selected from the series of medical image frames, in a first portion of the display screen;
displaying, in a second portion of the display screen, a first alternate candidate medical image frame of the series of medical image frames which precedes or follows the candidate medical image frame in the series of medical image frames; and
displaying the first alternate candidate medical image frame in the first portion of the display screen when the first alternate candidate medical image frame displayed in the second portion of the display screen is selected, via the user interface, for display on the first portion of the display screen.

14. The system according to claim 13, wherein the first portion of the display screen has an area which is greater than an area of the second portion of the display screen.

15. The system according to claim 13, wherein the second portion of the display screen comprises a movable window.

16. The system according to claim 13, wherein the second portion of the display screen comprises a docked or fixed window.

17. The system according to claim 13, wherein the processor executes further instructions for displaying a marker in the second portion of the display screen that identifies the candidate medical image frame.

18. The system according to claim 13, wherein the series of image frames comprise x-ray image frames.

19. The system according to claim 13, wherein the series of image frames comprise angiography image frames.

20. The system according to claim 13, wherein the candidate image frame comprises a candidate end of diastole image frame or a candidate end of systole image frame.

21. The system according to claim 13, wherein the first alternate candidate medical image frame precedes the candidate medical image frame and wherein the processor executes further instructions for displaying, in the second portion of the display screen, a second alternate medical image frame of the series of medical image frames which follows the candidate medical image frame in the series of medical image frames.

22. The system according to claim 21, wherein the processor executes further instructions for displaying the second alternate candidate medical image in the first portion of the display screen when the second alternate candidate medical image frame displayed in the second portion of the display screen is selected, via the user interface, for display on the first portion of the display screen.

23. The system according to claim 21, wherein the candidate medical image frame comprises a candidate end of diastole image frame or a candidate end of systole image frame, the first alternate candidate medical image frame comprises a first alternate candidate end of diastole image frame or a first alternate candidate end of systole image frame, and the second alternate candidate medical image frame comprises a second alternate candidate end of diastole image frame or a second alternate candidate end of systole image frame.

24. The system according to claim 13, wherein the processor executes further instructions for displaying the candidate medical image in the first portion of the display screen when the candidate medical image frame displayed in the second portion of the display screen is selected, via the user interface, for display on the first portion of the display screen.

25. The system according to claim 13, wherein the user interface comprises a monitor.

26. The system according to claim 25, wherein the user interface further comprises at least one of a keyboard, microphone, mouse, touch screen, and joy stick.

27. A system for viewing a series of medical image frames, the system comprising:
means for displaying a candidate medical image frame selected from the series of medical image frames, in a first portion of a display screen of a user interface;
means for displaying, in a second portion of the display screen, a first alternate candidate medical image frame of the series of medical image frames which precedes or follows the candidate medical image frame in the series of medical image frames; and
means for displaying the first alternate candidate medical image frame in the first portion of the display screen when the first alternate candidate medical image frame displayed in the second portion of the display screen is selected, via the user interface, for display on the first portion of the display screen.

28. The system according to claim 27, wherein the first portion of the display screen has an area which is greater than an area of the second portion of the display screen.

29. The system according to claim 27, wherein the second portion of the display screen comprises a movable window.

30. The system according to claim 27, wherein the second portion of the display screen comprises a docked or fixed window.

31. The system according to claim 27, further comprising means for displaying a marker in the second portion of the display screen for identifying the candidate medical image frame.

32. The system according to claim 27, wherein the series of image frames comprise x-ray image frames.

33. The system according to claim 27, wherein the series of image frames comprise angiography image frames.

34. The system according to claim 27, wherein the candidate image frame comprises a candidate end of diastole image frame or a candidate end of systole image frame.

35. The system according to claim 27, wherein the first alternate candidate medical image frame precedes the candidate medical image frame and further comprising means for displaying, in the second portion of the display screen, a second alternate medical image frame of the series of medical image frames which follows the candidate medical image frame in the series of medical image frames.

36. The system according to claim 35, further comprising means for displaying the second alternate candidate medical image in the first portion of the display screen when the second alternate candidate medical image frame displayed in the second portion of the display screen is selected, via the user interface, for display on the first portion of the display screen.

37. The system according to claim 35, wherein the candidate medical image frame comprises a candidate end of diastole image frame or a candidate end of systole image frame, the first alternate candidate medical image frame comprises a first alternate candidate end of diastole image frame or a first alternate candidate end of systole image frame, and the second alternate candidate medical image frame comprises a second alternate candidate end of diastole image frame or a second alternate candidate end of systole image frame.

38. The system according to claim 27, further comprising means for displaying the candidate medical image in the first portion of the display screen when the candidate medical image frame displayed in the second portion of the display screen is selected, via the user interface, for display on the first portion of the display screen.

39. A computer-readable medium having stored thereon computer-executable instructions which when executed by a computer system cause the system to perform a method for viewing a series of medical image frames, the method comprising steps of:
displaying a candidate medical image frame selected from the series of medical image frames, in a first portion of a display screen of a user interface;
displaying, in a second portion of the display screen, a first alternate candidate medical image frame of the series of medical image frames which precedes or follows the candidate medical image frame in the series of medical image frames; and
displaying the first alternate candidate medical image frame in the first portion of the display screen when the first alternate candidate medical image frame displayed in the second portion of the display screen is selected, via the user interface, for display on the first portion of the display screen.

40. The medium according to claim 39, wherein the first portion of the display screen has an area which is greater than an area of the second portion of the display screen.

41. The medium according to claim 39, wherein the second portion of the display screen comprises a movable window.

42. The medium according to claim 39, wherein the second portion of the display screen comprises a docked or fixed window.

43. The medium according to claim 39, wherein the candidate medical image frame in the second portion of the display screen is identified by a marker.

44. The medium according to claim 39, wherein the series of image frames comprise x-ray image frames.

45. The medium according to claim 39, wherein the series of image frames comprise angiography image frames.

46. The medium according to claim 39, wherein the candidate image frame comprises a candidate end of diastole image frame or a candidate end of systole image frame.

47. The medium according to claim 39, wherein the first alternate candidate medical image frame precedes the candidate medical image frame and wherein the method further comprises the step of displaying, in the second portion of the display screen, a second alternate medical image frame of the series of medical image frames which follows the candidate medical image frame in the series of medical image frames.

48. The medium according to claim 47, wherein the method further comprises the step of displaying the second alternate candidate medical image in the first portion of the display screen when the second alternate candidate medical image frame displayed in the second portion of the display screen is selected, via the user interface, for display on the first portion of the display screen.

49. The medium according to claim 47, wherein the candidate medical image frame comprises a candidate end of diastole image frame or a candidate end of systole image frame, the first alternate candidate medical image frame comprises a first alternate candidate end of diastole image frame or a first alternate candidate end of systole image frame, and the second alternate candidate medical image frame comprises a second alternate candidate end of diastole image frame or a second alternate candidate end of systole image frame.

50. The medium according to claim 39, wherein the method further comprises the step of displaying the candidate medical image in the first portion of the display screen when the candidate medical image frame displayed in the second portion of the display screen is selected, via the user interface, for display on the first portion of the display screen.
